(19) United States
(12) Patent Application Publication
(10) Pub. No.: US 2026/0259468 A1
(43) Pub. Date: Sep. 3, 2026

(54) FIBER BASED PROCESSING SYSTEM

(71) Applicant: COGNIFIBER LTD., Rosh Ha’Ayin (IL)

(72) Inventors: Eyal COHEN, Gedera (IL); Zeev ZALEVSKY, Rosh Ha'Ayin (IL); Maya YEVNIN, Tel Aviv (IL)

(21) Appl. No.: 18/865,754

(22) PCT Filed: Jun. 19, 2023
(86) PCT No.: PCT/IL2023/050635

§ 371 Date: Nov. 14, 2024

Related U.S. Application Data
(60) Provisional application No. 63/354,019, filed on Jun. 21, 2022.

(51) Int. Cl. G02F 1/35

(52) U.S. Cl. CPC G02F 1/3521

(57) ABSTRACT

An optical processing unit is presented to be used as a basic block of an optical processor system. The optical processing unit is configured to implement a predetermined processing task on an input light signal, and comprises: an input fiber unit for propagating therethrough said input light signal and a weighting light beam; an output fiber unit; and a nonlinear all-optical modulator located upstream of the output fiber unit to be exposed to interaction of the input light signal and the weighting light beam, said nonlinear all-optical modulator being configured to apply, via said interaction, spatial modulation of the weighting light beam to a light filed of the input light signal, to thereby produce spatially modulated light field corresponding to said input light signal, and allow propagation of said spatially modulated light field through the output fiber unit to a detection plane.

### TECHNOLOGICAL FIELD AND BACKGROUND

The present disclosure is in the field of fiber optics and relates to an optical fiber-based photonic processor, which is particularly useful in optical data communication, as well as optical computation devices and may also be useful in optically integrated artificial neuron networks (ANN's).

Photonic computing utilizes manipulation on light (photons) to perform computation processes as opposed to the conventional electron-based computation. Generally, the fundamental building block of modern electronic computers is the transistor. In photonic computers, electronic components are replaced with optical ones, an equivalent optical transistor, i.e., photonic computer system use light pulses to form the basis of logic gates rather than electrical transistors.

Conventional optical processing systems typically utilizes electronic-optical hybrid processing, generally referred to as optoelectronic processing. In these systems optical signals are used for data transmission and for certain processing operations, and can then be converted to electronic signals for certain other processing operations. Such optoelectronic devices may lose about 30% of their energy while converting electronic energy into photons and back. Moreover, the conversion of optical to electronic signals and back slows the transmission and processing of data. High research efforts are directed at all-optical computing, which eliminates the need for optical-electrical-optical (OEO) conversions, thus lessening the need for electrical power and increasing processing rate.

Optical computing enables faster computation rates as compared to electronic systems, owing to the fact that manipulations on light pulses may be faster and allows transmission of higher bandwidth of information.

### GENERAL DESCRIPTION

There is a need in the art for a novel approach for using optical fibers to implement various all-optical signal processing tasks, in particular suitable for use in neural networks.

The present disclosure provides a novel fiber-based all-optical photonic processor configured and operable to perform various processing tasks implemented by optical manipulations involving linear effects and nonlinear effects (such as plasma dispersion effect). Some examples of the computation tasks that can be performed by the photonic processor of the present disclosure include convolution, matrix multiplication, spatial filtering of optical fields, etc.

The photonic processor of the present disclosure includes a certain number N (N≥1) of basic block, each configured as a processing unit. The processing unit includes such functional parts as an arrangement of multi-mode optical fibers defining an input fiber unit and an output fiber unit (with respect to general light propagation direction through the processing unit), and a nonlinear optical modulator. The nonlinear optical modulator is located upstream of the output fiber unit, while may be located outside the input fiber unit (e.g., one of the input fibers) downstream thereof and/or may be integrated within the input fiber unit.

The nonlinear optical modulator may be configured using any known suitable technique to implement nonlinear all optical effects, such as, for example, photoabsorbance, electro-optical effect (based on Kerr effect induced by interaction of two optical fields), photorefractive effect (change in refractive index in a material owing to the optically induced redistribution of electrons and holes), etc. The optical modulator can be configured as a thin semiconductor element, e.g. can be configured as a Si or Ge core fiber or can be doped in glass of the fiber.

The input fiber unit is configured and operable to propagate an input light signal and a weighting light beam to enable interaction of the input light signal and the weighting light beam with the nonlinear optical modulator. In some embodiments, such interaction occurs at the output of the input fiber unit where the optical modulator is located, and in some other embodiments such interaction occurs during the light signal and weighting beam propagation along the same input fiber containing the optical modulator integral with said fiber, or a combination of both of these implementations. The latter is a so-called “hybrid” configuration, in which in one axis the nonlinearity medium is integrated in the fiber and in the second axis it is external material.

It should be understood that the light signal and the weighting light beam are different from one another in at least one optical property in order to avoid interference between them. In some embodiments, this can be achieved by using the weighting light beam of a wavelength different from that of the light signal. In this case, interaction between them is generated by optical nonlinearity. For example, the nonlinear optical modulator may be configured to perform plasma dispersion effect, photo-refractive effect, etc. In some other embodiments, the weighting light beam may be of substantially the same wavelength as the light signal. In this case, the nonlinear optical modulator may be configured to perform cross phase modulation effect, soliton effects, Kerr effect, etc.

The optical properties of the weighting light beam (wavelength and intensity) are selected such that the weighting light beam excites the optical modulator to induce the nonlinear all-optical effect (change of optical property of the modulator) which properly modulates the input light beam interacting therewith (e.g., passing therethrough). More specifically, in some non-limiting examples, the weighting light beam, while interacting with the optical modulator, creates charge carriers (electron hole pairs) and is efficiently absorbed. The so-created charge carriers affect corresponding modulation of the input light signal interacting with the optical modulator allowing transmission of the modulated light signal through the optical modulator.

Thus, the processing task, being a predetermined function applied to an input light signal, involves an effect of optical modulation applied to the input light signal by the weighting light beam, via the interaction of both the input light signal and the weighting light beam with the optical modulator.

Various functions (e.g. Fourier and/or imaging) involved in a specific processing task utilize the input light signal and the weighting beam of the same or different domains (frequency and/or spatial domains). Generally, the input light signal and the weighting light beam may propagate through the same or different fibers of the input fiber unit. Indeed, this is possible irrespective of whether they are to exit the input fiber unit in the same or different domains. The input light signal and the weighting beam have different optical properties (e.g., wavelengths, polarizations, phases, etc.).

The input light signal and weighting light beam may be configured to have their primary Fourier planes at different locations. The length of the input fiber (as well as refractive index profile thereof) can be determined so that, at the exit of the input fiber, one of the input signal and the weighting beam is Fourier transformed and the other of them is not, or both are Fourier transformed (while they have undergone a different number of Fourier transforms during the propagation through the input fiber unit).

As will be described further below, in case the input light signal and the weighting light beam are of the same domain, interaction of both with the optical modulator results in multiplication of the input light signal by the weighting beam; and in case the input light signal arrives to the interaction region while being in a frequency domain, its interaction with the optical modulator being excited/spatially modulated by the weighting light beam, results in a frequency filtering of the input light signal. To this end, the input fiber unit, as well as the output fiber unit, are configured in accordance with the predetermined function/processing task to be applied.

In some embodiments, the input fiber unit includes at least one graded-index (GRIN) light guiding unit, which may be GRIN fiber or rod or planar waveguide. The construction and operation of such GRIN light guiding unit are known per se and therefore need not be specifically described, except to note that due to the fact that in such light guiding unit refractive index decreases from periphery to central region thereof, the light passing through GRIN light guiding unit undergoes continual refocusing (i.e. lensing effect).

In the description below, such GRIN light guiding unit is referred to as GRIN fiber, but it should be noted that this term should be interpreted broadly covering also GRIN rod and planar waveguide.

The length and temperature of the input fiber unit, as well as those of the output fiber unit, which utilize(s) GRIN fiber(s) are also selected in accordance with the optical processing to be performed, i.e., depending on whether the plane on which the light exits the fiber unit is a Fourier plane.

For example, in some embodiments, the predetermined task/function is convolution of the input light signal. In this case, the input fiber unit may be configured to implement Fourier transform of both the input light signal [symbol] and the weighting light beam [symbol] and allow modulation of the input light signal by the weighting light beam via interaction of both with the optical modulator, yielding [symbol] · [symbol] (where x marks the signal and w the weights). The output fiber unit is configured to implement inverse Fourier transform of the modulated input light signal while directing it to a detection plane, giving an overall operation of [symbol] ⁻¹( [symbol] · [symbol] ).

As will be described below, in some embodiments, the input light signal and the weighting beam may propagate through different fibers of the input fiber unit, in which case the optical modulator is located at the outputs of these fibers. In such embodiments, both fibers of the input fiber unit may be configured to perform Fourier transforms of respective light fields; or both fibers may be configured as imaging fibers; or one of these fibers is configured to perform Fourier transform of the input light signal and the other fiber through which the weighting light beam propagates is the imaging fiber.

In some other embodiments, the input light signal and the weighting beam propagate through the same fiber of the input fiber unit. In this case, in some embodiments, the optical modulator may be located at the output of the fiber. The fiber through which the input light signal and the weighting light beam propagate may be configured to perform Fourier transform of both the input light signal and the weighting beam, or may be configured as an imaging fiber for both of them, or may be configured to perform Fourier transform on one of them and imaging on the other. This depends on the wavelengths of the beams and the fiber length.

In some other examples, with this configuration of the common input fiber propagating both the input light signal and the weighting light beam, the optical modulator may be integrated within the fiber extending therealong. This can be implemented by configuring the optical modulator as the material composing the core through which both signals propagate, or by doping such nonlinear optical material in the glass of the input fiber. Such configurations provide that the input light signal and the weighting light beam undergo multiple interactions with the optical modulator during their propagation along the fiber thus resulting in matrices multiplication at the output of the input fiber unit. In some examples, this input fiber may be configured to perform Fourier transform of light passing therethrough, in which case the output fiber unit is configured to perform inverse Fourier transform thus providing convolution of the input light signal by the weighting function.

Thus, according to one broad aspect of the present disclosure, it provided an optical processor system comprising at least one optical processing unit, the optical processing unit being configured to implement a predetermined processing task on an input light signal and comprising an arrangement of optical fibers defining: an input fiber unit configured to propagate the input light signal and a weighting light beam having at least one optical property different from that of the input light signal towards an output plane located in accordance with said predetermined function to be implemented, an output fiber unit spaced-apart from the input fiber unit along a general light propagation direction through the optical processing unit and configured to propagate light to a detection plane, and a nonlinear all-optical modulator upstream of the output fiber unit, wherein the nonlinear all-optical modulator is exposed to interaction with light fields corresponding to the input light signal and the weighting light beam and is switchable by interaction with the light field corresponding to the weighting light beam into a spatial modulating state to apply spatial modulation of the weighting light beam to the light field corresponding to the input light signal, to thereby produce spatially modulated light field corresponding to said input light signal, and allowing its propagation through the output fiber unit to the detection plane.

In some embodiments, the nonlinear all-optical modulator of the optical processing unit is accommodated in the output plane and is exposed to the interaction with the light fields corresponding to the input light signal and the weighting light beam to thereby apply said spatial modulation of the weighting light beam to the light field corresponding to the input light signal and produce the spatially modulated light field corresponding to said input light signal.

The input fiber unit of the optical processing unit may include a common input fiber configured to propagate both the input light signal and the weighting light beam, or, alternatively, the input fiber unit of the optical processing unit may include first and second input fibers configured to propagate the input light signal and the weighting light beam, respectively.

In some embodiments, where the input fiber unit of the optical processing unit includes a common input fiber configured to propagate both the input light signal and the weighting light beam, the nonlinear all-optical modulator comprises a nonlinear medium integral with this common input fiber to thereby apply the spatial modulation of the weighting light beam to the light field corresponding to the input light signal during the input light signal and weighting light beam propagation through the common input fiber and thereby produce the spatially modulated light field corresponding to said input light signal.

In some embodiments, the nonlinear all-optical modulator has a first nonlinear medium integral with the input fiber and a second nonlinear medium at the output of the input fiber.

In some embodiments, the optical processing unit has the following configuration: The input fiber unit includes at least one graded-index (GRIN) fiber configured to apply a Fourier transform function to at least one of the input light signal and the weighting light beam, the output plane being a Fourier plane with respect to light input of the input fiber unit for the wavelength(s) of at least one of the input light signal and the weighting light beam. The output fiber unit includes a GRIN fiber configured to apply a successive Fourier transform function to the spatially modulated light field passing therethrough, the detection plane being a Fourier plane with respect to light input of the GRIN fiber of the output fiber unit for the spatially modulated light field (i.e. for the wavelength of the input light signal).

In some examples, the input light signal and the weighting light beam propagate through first and second GRIN fibers of the input fiber unit which are configured to apply the Fourier transforms to, respectively, the input light signal and the weighting light beam. In this case, the nonlinear all-optical modulator of the optical processing unit is accommodated in the output plane and be exposed to the interaction with the light fields corresponding to the input light signal and the weighting light beam.

In some other examples, the input light signal and the weighting light beam propagate through the same GRIN fiber, which is configured to apply the Fourier transform to both of the input light signal and the weighting light beam, or is configured to apply the Fourier transform only to the input light signal. In such cases, the nonlinear all-optical modulator may be accommodated in the output plane, or the nonlinear all-optical modulator may be integral with the GRIN fiber (e.g. a core of the GRIN fiber may be configured as the nonlinear all-optical modulator) thereby applying the spatial modulation of the weighting light beam to the input light signal during their propagation through said GRIN fiber.

In some embodiments, the predetermined processing task implemented by the processing unit is a convolution between the input light signal and the weighting light beam, resulting from the interaction of Fourier transforms of the input light signal and the weighting light beam with the nonlinear all-optical modulator producing the spatially modulated light field, and the successive Fourier transform of the spatially modulated light field corresponding to the input light signal.

In these embodiments, the input light signal and the weighting light beam may propagate through respective first and second GRIN fibers of the input fiber unit configured to apply the Fourier transforms thereto, and the nonlinear all-optical modulator is thus accommodated in the output plane of the input fiber unit. Alternatively, the input light signal and the weighting light beam may propagate through the same GRIN fiber which is configured to apply the Fourier transform to both of them, in which case the nonlinear all-optical modulator is either a separate element accommodated in the output plane of the input fiber unit or is integral with said GRIN fiber to thereby apply the spatial modulation of the weighting light beam to the input light signal during their propagation through said GRIN fiber.

In some embodiments, the predetermined processing task implemented by the processing unit is filtering of selected spatial frequencies of the input light signal, resulting from the interaction of Fourier transform of the input light signal and the weighting light beam with the nonlinear all-optical modulator, and the successive Fourier transform of the spatially modulated light field corresponding to said input light signal.

In some examples of these embodiments, the input light signal and the weighting light beam may propagate through first and second fibers, respectively, where at least the first fiber is the GRIN fiber configured to implement the Fourier transform of the input light signal, and the second fiber is configured as an imaging fiber for the weighting light beam. In this case, the nonlinear all-optical modulator is a separate element accommodated in the output plane. In some other examples, the input light signal and the weighting light beam propagate through the same GRIN fiber of the input fiber unit which is configured to apply the Fourier transform to the input light signal and is configured as an imaging fiber with respect to the weighting light beam. In this case, the nonlinear all-optical modulator may be a separate element located in the output plane or may be integral with the GRIN fiber (i.e. may be constituted by properly configured GRIN fiber) applying the spatial modulation of the weighting light beam to the Fourier transform of the input light signal during their propagation through said GRIN fiber.

In yet further embodiments, the predetermined processing task implemented by the processing unit may be signal multiplication between the input light signal and the weighting light beam, resulting from the interaction of light fields corresponding to the input light signal and the weighting light beam with the nonlinear all-optical modulator, and successive imaging of the spatially modulated light field corresponding to said input light signal on the detection plane. In such embodiments, the input fiber unit may be configured such that the output plane is an image plane for light input of the input fiber unit with respect to both the input light signal and the weighting light beam, and the output fiber unit is configured such that the detection plane is an imaging plane for light input of the output fiber unit with respect to the input light signal.

According to another broad aspect of the invention, it provides an optical processing unit configured to implement a predetermined processing task on an input light signal, the optical processing unit comprising: an input fiber unit for propagating therethrough said input light signal and a weighting light beam; an output fiber unit; and a nonlinear all-optical modulator located upstream of the output fiber unit to be exposed to interaction of the input light signal and the weighting light beam, said nonlinear all-optical modulator being configured to apply, via said interaction, spatial modulation of the weighting light beam to a light filed of the input light signal, to thereby produce spatially modulated light field corresponding to said input light signal, and allow propagation of the spatially modulated light field through the output fiber unit to a detection plane.

In some embodiments, the input fiber unit comprises a common input fiber for propagating both the input light signal and the weighting light beam. The nonlinear all-optical modulator may be located between the input fiber unit and the output fiber unit being in an output plane of the input fiber unit. In some other embodiments, the nonlinear all-optical modulator is entirely integral with said common input fiber, such that the input light signal and the weighting light beam undergo said interaction with said nonlinear all-optical modulator during their propagation through the common input fiber; or is of the hybrid configuration, according to which it includes a first nonlinear medium integral with said common input fiber.

In yet further embodiments, the nonlinear all-optical modulator comprises at least a first nonlinear medium integral with said common input fiber, such that the input light signal and the weighting light beam undergo said interaction with said first nonlinear medium during their propagation through the common input fiber, to thereby apply the spatial modulation of the weighting light beam in a first axis to the input light signal, and producing a first-axis modulated light field of the input light signal, and a second nonlinear medium at an output plane of the input fiber unit.

In some embodiments, the input fiber unit comprises first and second input fibers for propagating, respectively, the input light signal and the weighting light beam. The nonlinear all-optical modulator is located between the input fiber unit and the output fiber unit being in an output plane of the input fiber unit.

The input fiber unit may include at least one input fiber configured as a GRIN fiber. The output fiber unit may also include at least one output fiber configured as a GRIN fiber.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIGS. 1A and 1B are schematic illustrations of an optical processor system of the present disclosure, wherein FIG. 1A shows an optical processor system utilizing a nonlinear all-optical modulator accommodated outside an input fiber unit, and FIG. 1B shows an optical processor system utilizing an input fiber unit including a nonlinear all-optical modulator integrated within the input fiber unit.

FIGS. 2A-2C exemplify different configurations of an optical processor unit suitable to be used in the optical processing system of FIGS. 1A and 1B, wherein FIGS. 2A and 2B show the optical processor unit having an input fiber unit including a common fiber for input light signal and weighting light beam propagation, and a nonlinear all-optical modulator located at the output of and/or inside the input fiber unit, and FIG. 2C shows an optical processor unit having an input fiber unit with different fibers for input light signal and weighting light beam propagation, respectively, and nonlinear all-optical modulator located at the output of the input fiber unit.

### DETAILED DESCRIPTION OF EMBODIMENTS

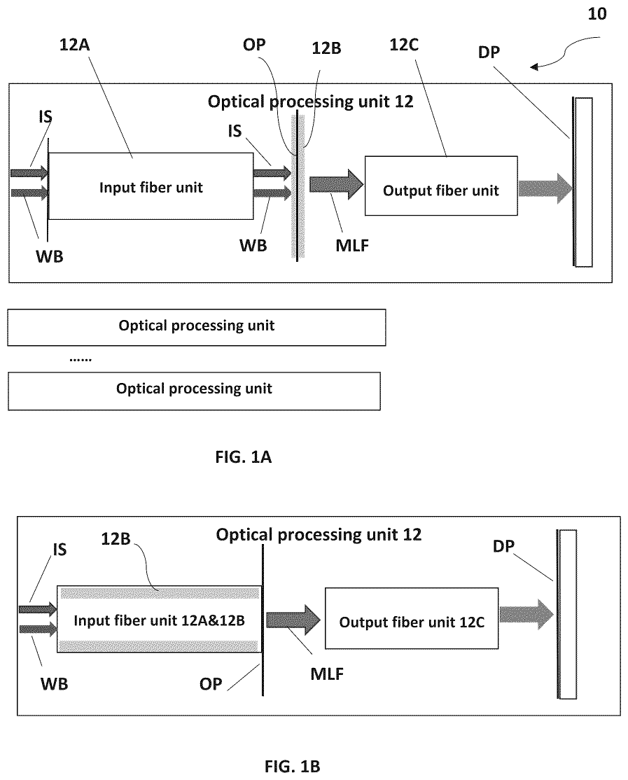

Referring to FIGS. 1A and 1B, there are schematically illustrated two examples, respectively, of an optical processor system 10 of the present disclosure configured and operable to implement various data processing/computation tasks/functions. The system 10 is a fiber-based photonic processing system, which may be used as an optical communication system or an optical computing system.

The optical processor system 10 includes at least one optical/photonic processing unit/computing unit 12, configured to implement predetermined processing task(s) on an input light signal IS. The processing unit 12 includes an arrangement of optical fibers (in some embodiments, multi-mode fibers) including an input fiber unit 12A which includes one or more input light propagating fibers for propagating of the input light signal IS and a weighting light beam WB therethrough, and an output fiber unit 12C spaced apart from the input fiber unit along the general light propagation direction through the processing unit 12 towards a detection plane DP. The processing unit 12 also includes a nonlinear all-optical modulator 12B.

The nonlinear all-optical modulator 12B can be a separate element located between output of the input fiber unit 12A and input of the output fiber unit 12C. In another example, the nonlinear all-optical modulator 12B can be implemented as an integral part of the input fiber unit. According to yet another example, the nonlinear all-optical modulator 12B can be configured as a hybrid structure including first nonlinear medium integral with the input fiber unit (common input fiber through which input light signal and weighting light beam propagate) and a second nonlinear medium located at the

As described above, the nonlinear all-optical modulator may be configured using any known suitable technique to implement a nonlinear all optical effect. Some specific non-limiting examples of such optical modulator include: photoabsorber (e.g. based on plasma dispersion effect), electro-optical modulator (based on Kerr effect), photorefractive modulator (responding to interaction with light by a change in refractive index due to optically induced redistribution of electrons and holes), cross phase modulation effect (the optical intensity of one beam influences the phase change of another beam), soliton effects (nonlinear effect balances the diffraction or dispersion).

In the description below, for simplicity, the nonlinear all-optical modulator is referred to as a photoabsorber. However, it should be understood that the principles of the technique of the present disclosure are not limited to this specific example, and the term “photoabsorber” should thus be interpreted broadly covering any known suitable type of nonlinear all-optical modulator.

In the example of FIG. 1A, the photoabsorber 12B is implemented as a separate element located in the propagation path of light output from the input fiber unit, being located in an output plane OP of the input fiber unit 12A. The photoabsorber 12B may be in the form of a thin semiconductor film (silicon, germanium), or a Si core fiber.

In the example of FIG. 1B, the photoabsorber 12B is integral with the input fiber unit 12A. The photoabsorber 12B can be implemented as the material composing the core through which can propagate both the input light signal IS and the weighting light beam WB, e.g. Si core. Thus, the input fiber unit 12A operates to both propagate the input light signal IS and the weighting light beam WB and allow their interaction with the photoabsorber 12B.

The photoabsorber 12B is switchable/excitable from its passive state into an active state in which it operates as a spatial light modulator. This will be described more specifically further below.

The input fiber unit 12A is configured for receiving the input light signal IS of a predetermined wavelength 21 and a weighting light beam WB having at least one optical property different from a respective property of the input light signal IS (e.g. wavelength, polarization, phase). In the present nonlimiting example, the weighting light beam WB has a predetermined wavelength 12 different from the wavelength λ₁ (λ₁≠λ₂) of the input light signal IS. For example, λ₁=1500 nm, and λ₂=1000 nm.

The input light signal IS and the weighting light beam WB propagate through the input fiber unit 12A (in a general propagation direction) towards the output plane OP.

The photoabsorber 12B is exposed to interaction with both the input light signal IS and the weighting light beam WB. In the example of FIG. 1A, the photoabsorber element 12B is located in the output plane OP and thus such interaction occurs when both the input light signal IS and the weighting light beam WB while exiting the input fiber unit are incident on the photoabsorber element 12B. In the example of FIG. 1B, the input light signal IS and the weighting light beam WB while propagating through the input fiber unit 12A undergo multiple interactions with the photoabsorber 12B.

The photoabsorber 12B is excitable/switchable by interaction with the weighting light beam WB to apply spatial modulation to the input light signal IS interacting therewith and thus produce spatially modulated light field MLF corresponding to the input light signal IS.

More specifically, interaction of the weighting light beam WB with the photoabsorber 12B (being either separate element at the output plane OP or integral with/extending along the input fiber through which both the input light signal IS and the weighting light beam WB propagate) excites the photoabsorber by inducing generation of free charged carriers (electron-hole pairs) and is efficiently absorbed by the photoabsorber 12B, resulting in a spatial modulation pattern within the photoabsorber 12B. As the input light signal IS interacts with the so-excited photoabsorber 12B, this affects corresponding spatial modulation of the input light signal IS producing the resulting modulated light signal/field MLF. The modulated light signal/field MLF can be transmitted through the photoabsorber 12B.

It should be understood that the optical properties of the weighting light beam WB (e.g. wavelength and intensity) can be selected such that the weighting light beam WB properly excites the photoabsorber 12B.

In the example of FIG. 1A, the photoabsorber 12B is located in the propagation path of light output from the input fiber unit 12A being in the output plane OP and is thus exposed to interaction with the input light signal IS and the weighting light beam WB emerging from the input fiber unit 12A. In the example of FIG. 1B, the core of the input fiber 12A is made of the photo-absorbing material and thus operates as photoabsorber 12B, and the input light signal IS and the weighting light beam WB undergo multiple interactions with the photoabsorber 12B during their propagation through the input fiber unit 12A.

The output fiber unit 12C is configured to receive and propagate the spatially modulated light field SML to direct a light field indicative thereof on the detection plane DP accommodated at a predetermined location in accordance with the predetermined function/processing task to be implemented by the processing unit 12. The input fiber unit 12A and the output fiber units 12C are configured in accordance with the desired processing function/task to be implemented, as will be described further below.

Thus, the processing task to be performed by the optical processing unit 12, which can be a predetermined function applied to the input light signal IS, involves an effect of spatial modulation applied to the input light signal IS by the weighting light beam WB via the interaction of both of them with the photoabsorber 12B.

Such predetermined function can for example be convolution, matrix multiplication, spatial filtering of optical fields, etc. The structure of the input fiber unit 12A and the length thereof, as well as those of the output fiber unit 12B are properly selected to implement desired optical processing of light passing therethrough as will be described further below.

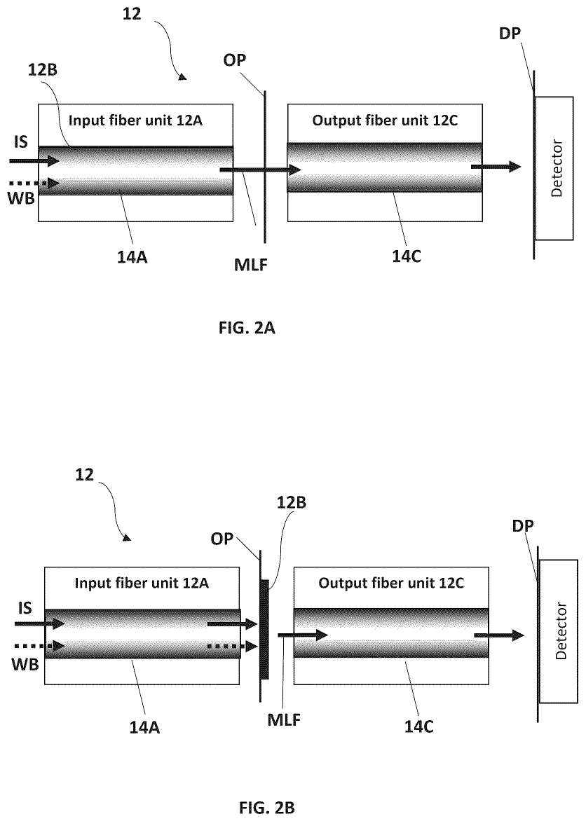

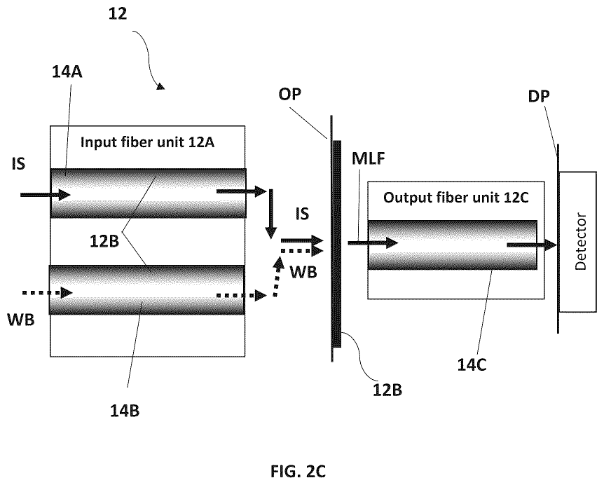

Reference is made FIGS. 2A to 2C exemplifying different configurations of an optical processor unit 12 of the present invention to implement various processing/computation tasks/functions on the input light signal IS. To facilitate understanding, the same reference numbers are used to identify similar components in all the examples described herein.

In the processing units exemplified in FIGS. 2A and 2B, the input fiber unit 12A includes a common input optical fiber 14A configured for receiving and propagating both the input light signal IS and the weighting light beam WB. As indicated above, the input light signal and the weighting light beam differ from one another in at least one optical property. In the present nonlimiting example, the input light signal and the weighting light beam have certain different wavelengths λ₁ and λ₂ (λ₁≠λ2). The output fiber unit 12C includes an output fiber 14C.

In the example of FIG. 2A, the photoabsorber 12B is integral with the fiber 14A (i.e., the core of fiber 14A is made of photo-absorbing material), while in the example of FIG. 2B, the photoabsorber 12B is a separate element located in the output plane OP at the output of the fiber 14A.

FIG. 2C exemplifies an optical processor unit 12 where the input fiber unit 12A includes a first input fiber 14A and a second input fiber 14B configured for receiving and propagating, respectively, the input light signal IS and the weighting light beam WB towards the output plane OP accommodated at a predetermined location in accordance with the predetermined function to be implemented. In this example, the photoabsorber 12B is a separate element located in said plane OP.

It should be understood, that, as described above, the input light signal IS and the weighting light beam WB may propagate in the same fiber or in separate fibers of the input fiber unit, irrespective of whether the predetermined function/task to be implemented involves the input light signal IS and the weighting light beam WB of the same or different domains (frequency and/or spatial domain) at the output of the input fiber unit.

Since the input light signal IS and the weighting light beam WB have different wavelengths, their primary Fourier planes are not in the same place, and thus propagation of both through the same fiber of properly selected length (as well as refractive index profile that can be adapted e.g. via heating), allows to determine their exit of the fiber with the same or different domains.

In both cases (i.e. common fiber or different fibers of the input fiber unit 12A for propagation of the input light signal IS and weighting light beam WB), the photoabsorber 12B may be inside said input fiber or fibers. Also, in the same domain operational mode, the interaction of the input light signal IS and the weighting light beam WB with the photoabsorber 12B results in multiplication of the input light signal by the weighting beam.

As described above, in some embodiments, the Hybrid configuration can be used according to which the nonlinear all-optical modulator 12B includes first and second non-linear media, one being integral with the unput fiber unit and the other being at the output plane of the input fiber unit. This can be implemented using the input fiber unit configuration of FIG. 2A or FIG. 2B, namely the configuration utilizing the common unput fiber for propagation of both the input light signal IS and the weighting light beam WB.

Hence, although not specifically shown, in the example of FIG. 2A the modulator 12B illustrated as being located inside the common input fiber 14A would constitute the first nonlinear medium, and a second non-linear medium would be located at the output plane OP. Similarly, in the example of FIG. 2B, the modulator 12B illustrated as being located at the output plane OP presents the second nonlinear medium while the first nonlinear medium would be located inside the fiber 14A. During the input light signal IS and weighting light beam WB propagation through then common input fiber 14A, interaction of both with the first nonlinear medium (12B in FIG. 2A) integral with the common input fiber 14A applies spatial modulation of the weighting light beam WB in a first axis to the light field corresponding to the input light signal, and interaction of the modulated input light signal and the weighting light beam with the second nonlinear medium (12B in FIG. 2B) located at the output of the common input fiber 14A applies spatial modulation of the weighting light beam in a second axis to the input light signal.

As mentioned above, the input fiber unit 12A, as well as the output fiber unit 12C, are configured in accordance with the predetermined function/processing task to be performed.

In some embodiments, the optical processing unit 12 is configured for implementing a convolution function. In this case, the processing unit 12 may have general configuration as in either one of the above examples of FIG. 2A to FIG. 2C, where fibers of the input and output fiber units 12A and 12B are graded-index (GRIN) fibers configured to apply Fourier transform function to light passing therethrough.

More specifically, the fiber 14A in the system configurations of FIGS. 2A and 2B or each of fibers 14A and 14B in the system configuration of FIG. 2C, is a GRIN fiber dimensioned to perform Fourier of the input light signal IS and the weighting light beam WB, i.e., the output plane OP is a Fourier plane with respect to light input of the input GRIN fiber(s). Consequently, considering the use of photoabsorber 12B located outside the input fiber unit 12A, the input light signal IS and the weighting light beam WB are in the frequency/spectral domain as they exit the input fiber unit 12A.

As shown in FIG. 2B, the photoabsorber 12B is accommodated in the output plane OP and is exposed to the interaction with the Fourier transform light fields of the input light signal IS and the weighting light beam WB. As mentioned above, the weighting light beam WB (e.g., of the predetermined wavelength λ₂) interacts with the photoabsorber 12B and excites it, while being efficiently absorbed by the photoabsorber, to thereby apply corresponding spatial modulation to the input light signal IS interacting with the photoabsorber 12B to produce the spatially modulated light field MLF. The so-produced spatially modulated light field MLF is a multiplication of the input light signal IS and the weighting light beam WB in the frequency/spectral domain, which then undergoes inverse Fourier transform while passing through the GRIN fiber 14C of the output fiber unit 12B resulting in the desired convolution function, i.e., convolution of the light signal IS over the weighting light beam WB. The detection plane DP is a Fourier plane with respect to light input of the fiber 14C.

In the example of FIG. 2A, the photoabsorber 12B is integral with the input fiber unit 12A as described above. In this case, the input light signal IS and the weighting light beam WB propagate along the common input GRIN fiber 14A and undergo multiple interactions with the photoabsorber 12B. The resulting modulated light field MLF at the output plane OP of the input fiber unit 12A may correspond to Fourier transform of multiple matrix multiplications of the input light signal IS and the weighting light beam WB.

This modulated light field MLF then undergoes inverse Fourier transform while passing through the GRIN fiber 14C of the output fiber unit 12B resulting in the desired convolution function. The detection plane DP is a Fourier plane with respect to light input of the fiber 14C.

Thus, in these examples, the convolution function is implemented by using GRIN fibers and the photoabsorber providing interaction of Fourier transforms of the input light signal IS and the weighting light beam WB with the photoabsorber 12B, and the successive Fourier transform of the spatially modulated light field MLF corresponding to the weighted input light signal IS.

In some other embodiments, the processing function/task is signal multiplication of the input light signal IS by the weighting light beam WB performed via imaging processes. Both the input light signal and the weighting light beam are of the same spatial domain. In such embodiments, GRIN fiber or standard fiber can be used. Considering the use of a standard fiber, any of the above configuration of the processing unit exemplified in FIG. 2A-2C can be used, where the fibers of the input fiber unit 12A and the output fiber unit 12C are configured as imaging fibers, i.e., the output plane OP is the image plane with respect to light input into the input fiber unit 12A, and the detection plane DP is the image plane with respect to light input to the output fiber unit 12C. If a GRIN fiber is used as the common input fiber for propagation of both the input signal and the weighting light beam, then the GRIN fiber is properly tailored so that both beams exit in the imaging plane.

In the configuration of FIGS. 2B and 2C, where the photoabsorber 12B is placed in the plane OP outside the fiber unit 12A, both the input light signal IS and the weighting light beam WB are guided by the input fiber unit 12A towards the photoabsorber 12B to interact therewith. Interaction of the photoabsorber 12B with the weighting light beam WB excites/switches the photoabsorber generating a spatial pattern therein corresponding to the spatial pattern of the weighting light beam WB while effectively absorbing this beam, and applying the corresponding spatial modulation to the input light signal IS being transmitted through the photoabsorber 12B to produce the modulated light field MLF propagating through the imaging fiber of the output fiber unit 12C to the detection plane DP. The resulting image has a spatial intensity profile corresponding to a product of multiplication of matrices of the input light signal IS and weighting light beam WB.

Thus, in this case, the predetermined processing task implemented by the processing unit 10 may be signal multiplication between the input light signal IS and the weighting light beam WB, resulting from imaging of the input light signal and the weighting light beam onto the photoabsorber which, via interactions with both of these light fields, generates the modulated light field MLF which is successively imaged on the detection plane DP.

In some other embodiments, the predetermined processing task implemented by the processing unit 10 includes filtering of selected spatial frequencies of the input light signal IS. This can be implemented using the processing unit configuration generally similar to that of FIG. 2C, i.e., the input fiber unit 12A includes first and second fibers 14A and 14B for propagating, respectively, the input light signal IS and the weighting light beam WB towards the photoabsorber 12B outside the input fiber unit 12A at the output plane OP. However, for the purposes of this embodiment, the first input fiber 14A is a GRIN fiber dimensioned to perform Fourier transform of the input light signal IS while the second input fiber 14B is the imaging fiber. The output plane OP is a Fourier plane with respect to light input of the first input fiber 14A and an image plane with respect to light input into second input fiber 14B. Also, the output fiber 14C is a GRIN fiber performing Fourier transform of light passing therethrough.

The photoabsorber 12B accommodated in the output plane OP is exposed to the interaction with light fields of different domains: Fourier transform of the input light signal IS and spatial pattern of the weighting light beam WB. The weighting light beam WB interacts with the photoabsorber 12B exciting/switching it into its modulating state and thus, while being efficiently absorbed by photoabsorber 12B, creates a spatial modulation pattern therein. By this, interaction of the input light signal IS with photoabsorber 12B affects amplification of selected spatial frequencies of the input light signal IS and allows transmission of these frequencies while attenuating and absorbing other spatial frequencies of the input light signal forming the modulated/filtered light field MLF.

This modulated light field MLF propagates through the output GRIN fiber 14C performing inverse Fourier transform of the modulated light field MLF while directing it onto the detection plane DP. The detection plane DP is a Fourier plane with respect to light input of the GRIN fiber 14C. More specifically, the modulated light field MLF is in the frequency domain as it enters the output GRIN fiber 14C. The output GRIN fiber 14C implements Fourier transform on the modulated light field MLF and the modulated light field MLF is then inversed/shifted to time/spatial domain including only the selected spatial frequencies.

Thus, the present disclosure provides fiber-based all-optical photonic/optical processing unit capable of performing various processing tasks, such as convolution, matrix multiplication, spatial filtering of optical fields, etc. Such processing unit can form a building block of an optical processor system.

1. An optical processor system comprising at least one optical processing unit configured to implement a predetermined processing task on an input light signal, the optical processing unit comprising an arrangement of optical fibers defining:
an input fiber unit configured to propagate therethrough the input light signal and a weighting light beam, having at least one optical property different from that of the input light signal. towards an output plane of the input fiber unit located in accordance with said predetermined function to be implemented,
an output fiber unit spaced-apart from said output plane of the input fiber unit along a general light propagation direction through the optical processing unit and configured to propagate light to a detection plane, and
a nonlinear all-optical modulator located upstream of the output fiber unit to be exposed to interaction with light fields corresponding to the input light signal and the weighting light beam, the nonlinear all-optical modulator is switchable into a spatial modulating state by interaction with the light field corresponding to the weighting light beam, thereby applying spatial modulation of the weighting light beam to the light field corresponding to the input light signal, to thereby produce spatially modulated light field corresponding to said input light signal, and allowing its propagation through the output fiber unit to the detection plane.

2. The optical processor system according to claim 1, wherein said nonlinear all-optical modulator of the optical processing unit is accommodated in said output plane and is exposed to the interaction with the light fields corresponding to the input light signal and the weighting light beam to thereby apply said spatial modulation of the weighting light beam to the light field corresponding to the input light signal and produce the spatially modulated light field corresponding to said input light signal.

3. The optical processor system according to claim 2, wherein the input fiber unit of the optical processing unit comprises a common input fiber configured to propagate both the input light signal and the weighting light beam.

4. The optical processor system according to claim 2, wherein the input fiber unit of the optical processing unit comprises first and second input fibers configured to propagate the input light signal and the weighting light beam, respectively.

5. The optical processor system according to claim 1, wherein the input fiber unit of the optical processing unit comprises a common input fiber configured to propagate both the input light signal and the weighting light beam, the nonlinear all-optical modulator being integral with said common input fiber to thereby apply said spatial modulation of the weighting light beam to the light field corresponding to the input light signal during the input light signal and weighting light beam propagation through said common input fiber and thereby produce the spatially modulated light field corresponding to said input light signal.

6. The optical processor system according to claim 5, wherein a core of said common input fiber is configured as the nonlinear all-optical modulator.

7. The optical processor system according to claim 1, wherein the input fiber unit of the optical processing unit comprises a common input fiber configured to propagate both the input light signal and the weighting light beam, the nonlinear all-optical modulator comprising: a first nonlinear medium integral with said common input fiber to thereby apply a spatial modulation of the weighting light beam in a first axis to the light field corresponding to the input light signal during the input light signal and weighting light beam propagation through said common input fiber, and a second nonlinear medium located at the output of said common input fiber to thereby apply a spatial modulation of the weighting light beam in a second axis to the input light signal, thereby producing the spatially modulated light field corresponding to said input light signal.

8. The optical processor system according to claim 1, wherein:
said input fiber unit comprises at least one graded-index (GRIN) fiber configured to apply a Fourier transform function to at least one of the input light signal and the weighting light beam, said output plane being a Fourier plane with respect to light input of said input fiber unit for said at least one of the input light signal and the weighting light beam, and
said output fiber unit comprises a GRIN fiber configured to apply a successive Fourier transform function to the spatially modulated light field passing therethrough, said detection plane being a Fourier plane with respect to light input of said GRIN fiber of the output fiber unit for said spatially modulated light field.

9. The optical processor system according to claim 8, wherein said input light signal and said weighting light beam propagate through first and second GRIN fibers of the input fiber unit which are configured to apply the Fourier transforms to, respectively, the input light signal and the weighting light beam.

10. The optical processor system according to claim 8, wherein said nonlinear all-optical modulator of the optical processing unit is accommodated in said output plane and is exposed to the interaction with the light fields corresponding to the input light signal and the weighting light beam to thereby apply said spatial modulation of the weighting light beam to the light field corresponding to the input light signal and produce the spatially modulated light field corresponding to said input light signal.

11. The optical processor system according to claim 8, wherein said input light signal and said weighting light beam propagate through the same GRIN fiber which is configured to apply the Fourier transform to both of the input light signal and the weighting light beam.

12. The optical processor system according to claim 8, wherein said input light signal and said weighting light beam propagate through the same GRIN fiber which is configured to apply the Fourier transform only to the input light signal.

13. The optical processor system according to claim 11, wherein said nonlinear all-optical modulator is integrated in said GRIN fiber thereby applying said spatial modulation of the weighting light beam to the input light signal during their propagation through said GRIN fiber and produce the spatially modulated light field corresponding to said input light signal.

14. The optical processor system according to claim 12, wherein said nonlinear all-optical modulator is integrated in said GRIN fiber thereby applying said spatial modulation of the weighting light beam to the input light signal during their propagation through said GRIN fiber and produce the spatially modulated light field corresponding to said input light signal.

15. The optical processor system according to claim 12, wherein the nonlinear all-optical modulator comprising: a first nonlinear medium integral with said same GRIN fiber of the input fiber unit to thereby apply a spatial modulation of the weighting light beam in a first axis to the light field corresponding to the input light signal during the input light signal and weighting light beam propagation through said common input fiber, and a second nonlinear medium located at the output of said same GRIN fiber of the input fiber unit to thereby apply a spatial modulation of the weighting light beam in a second axis to the input light signal, thereby producing the spatially modulated light field corresponding to said input light signal.

16. The optical processor system according to claim 13, wherein the nonlinear all-optical modulator comprising: a first nonlinear medium integral with said same GRIN fiber of the input fiber unit to thereby apply a spatial modulation of the weighting light beam in a first axis to the light field corresponding to the input light signal during the input light signal and weighting light beam propagation through said common input fiber, and a second nonlinear medium located at the output of said same GRIN fiber of the input fiber unit to thereby apply a spatial modulation of the weighting light beam in a second axis to the input light signal, thereby producing the spatially modulated light field corresponding to said input light signal.

17. The optical processor system according to claim 8, wherein the predetermined processing task implemented by the processing unit is a convolution between the input light signal and the weighting light beam, resulting from the interaction of Fourier transforms of the input light signal and the weighting light beam with the nonlinear all-optical modulator producing said spatially modulated light field, and the successive Fourier transform of the spatially modulated light field corresponding to said input light signal.

18. The optical processor system according to claim 17, wherein said input light signal and said weighting light beam propagate through first and second GRIN fibers of the input fiber unit which are configured to apply the Fourier transforms to, respectively, the input light signal and the weighting light beam.

19. The optical processor system according to claim 18, wherein said nonlinear all-optical modulator of the optical processing unit is accommodated in said output plane and is exposed to the interaction with the light fields corresponding to the input light signal and the weighting light beam to thereby apply said spatial modulation of the weighting light beam to the light field corresponding to the input light signal and produce the spatially modulated light field corresponding to said input light signal.

20. The optical processor system according to claim 17, wherein said input light signal and said weighting light beam propagate through the same GRIN fiber which is configured to apply the Fourier transform to both of the input light signal and the weighting light beam.

21. The optical processor system according to claim 20, wherein said nonlinear all-optical modulator is integrated within said GRIN fiber thereby applying said spatial modulation of the weighting light beam to the input light signal during their propagation through said GRIN fiber and produce the spatially modulated light field corresponding to said input light signal.

22. The optical processor system according to claim 8, wherein the predetermined processing task implemented by the processing unit is filtering of selected spatial frequencies of the input light signal, resulting from the interaction of Fourier transform of the input light signal and the weighting light beam with the nonlinear all-optical modulator, and the successive Fourier transform of the spatially modulated light field corresponding to said input light signal.

23. The optical processor system according to claim 22, wherein said input light signal and said weighting light beam propagate through first and second fibers, respectively, at least the first fiber being the GRIN fiber configured to implement the Fourier transform of the input light signal, and the second fiber being configured as an imaging fiber for the weighting light beam.

24. The optical processor system according to claim 23, wherein said nonlinear all-optical modulator of the optical processing unit is accommodated in said output plane to be exposed to the interaction with the light fields corresponding to the input light signal and the weighting light beam.

25. The optical processor system according to claim 22, wherein said input light signal and said weighting light beam propagate through the same GRIN fiber of the input fiber unit which is configured to apply the Fourier transform to the input light signal and is configured as an imaging fiber with respect to the weighting light beam.

26. The optical processor system according to claim 25, wherein said nonlinear all-optical modulator is integrated within the GRIN fiber thereby applying said spatial modulation of the weighting light beam to the Fourier transform of the input light signal during their propagation through said GRIN fiber.

27. The optical processor system according to claim 1, wherein the predetermined processing task implemented by the processing unit is signal multiplication between the input light signal and the weighting light beam, resulting from the interaction of light fields corresponding to the input light signal and the weighting light beam with the nonlinear all-optical modulator, and successive imaging of the spatially modulated light field corresponding to said input light signal on the detection plane, the input fiber unit being configured such that the output plane is an image plane for light input of the input fiber unit with respect to both the input light signal and the weighting light beam, and the output fiber unit is configured such that the detection plane is an imaging plane for light input of the output fiber unit with respect to the input light signal.

28. The optical processor system according to claim 1, wherein the nonlinear optical modulator is configured and operable based on one of the following effects: plasma dispersion effect, photo-refractive effect, cross phase modulation effect, soliton effects, Kerr effect.

29. An optical processing unit configured to implement a predetermined processing task on an input light signal, the optical processing unit comprising: an input fiber unit for propagating therethrough said input light signal and a weighting light beam; an output fiber unit; and a nonlinear all-optical modulator located upstream of the output fiber unit to be exposed to interaction of the input light signal and the weighting light beam, said nonlinear all-optical modulator being configured to apply, via said interaction, spatial modulation of the weighting light beam to a light filed of the input light signal, to thereby produce spatially modulated light field corresponding to said input light signal, and allow propagation of the spatially modulated light field through the output fiber unit to a detection plane.

30. The optical processing unit according to claim 29, wherein the input fiber unit comprises a common input fiber for propagating both the input light signal and the weighting light beam.

31. The optical processing unit according to claim 30, wherein the nonlinear all-optical modulator is located between the input fiber unit and the output fiber unit being in an output plane of the input fiber unit.

32. The optical processing unit according to claim 30, wherein the nonlinear all-optical modulator is integral with said common input fiber, such that the input light signal and the weighting light beam undergo said interaction with said nonlinear all-optical modulator during their propagation through the common input fiber.

33. The optical processing unit according to claim 30, wherein the nonlinear all-optical modulator comprises at least a first nonlinear medium integral with said common input fiber, such that the input light signal and the weighting light beam undergo said interaction with said first nonlinear medium during their propagation through the common input fiber, to thereby apply the spatial modulation of the weighting light beam in a first axis to the input light signal, and producing a first-axis modulated light field of the input light signal.

34. The optical processing unit according to claim 31, wherein the nonlinear all-optical modulator further comprises a second nonlinear medium at an output plane of the input fiber unit, such that the first axis modulated light field and the weighting light beam undergo an additional interaction with said second nonlinear medium at the output plane, said additional interaction thereby applying the spatial modulation of the weighting light beam in a second axis to the first-axis modulated light field of the input light signal.

35. The optical processing unit according to claim 29, wherein the input fiber unit comprises first and second input fibers for propagating, respectively, the input light signal and the weighting light beam, and wherein the nonlinear all-optical modulator is located between the input fiber unit and the output fiber unit being in an output plane of the input fiber unit.

36. The optical processing unit according to claim 29, wherein the input fiber unit comprises at least one input fiber configured as a GRIN fiber.

37. The optical processing unit according to claim 36, wherein the output fiber unit comprises at least one output fiber configured as a GRIN fiber.
